(19) United States
(12) Patent Application Publication
(10) Pub. No.: US 2026/0197053 A1
(43) Pub. Date: Jul. 9, 2026

(54) Reception of Non-Orthogonal Multiple Access of a Sensing and Communication Signal

(71) Applicant: Vestel Elektronik Sanayi ve Ticaret A.S., Manisa (TR)

(72) Inventors: Ebubekir Memisoglu, Istanbul (TR); Halise Türkmen, Istanbul (TR); Hüseyin Arslan, Istanbul (TR)

(21) Appl. No.: 19/130,583

(22) PCT Filed: Nov. 18, 2022
(86) PCT No.: PCT/EP2022/082508

§ 371 Date: May 16, 2025

(51) Int. Cl. H04B 7/06; H04W 72/044

(52) U.S. Cl. CPC H04B 7/0626; H04W 72/044

(57) ABSTRACT

Methods and techniques are described for determining from a received wireless communication signal channel state information CSI of a communication signal and a sensing signal that are included in the wireless communication signal. The communication signal and sensing signal are multiplexed in a non-orthogonal manner. The sensing CSI is determined using the sensing signal that is known and the received wireless communication signal. Then, based on the sensing CSI, a communication signal portion of the wireless communication signal is determined. Said portion is used together with a reference signal also included in the wireless communication signal to determine the communication CSI. With the known communication CSI and communication signal portion, the communication signal is obtained. The CSI of the communication signal and sensing signal may be determined together with the communication signal in an iterative manner, enabling robust separation of communication and sensing signal within a joint communication and sensing environment.

### CROSS-REFERENCE TO RELATED APPLICATION

This application is the United States national phase of International Patent Application No. PCT/EP2022/082508 filed Nov. 18, 2022, the disclosure of which is hereby incorporated by reference in its entirety.

### BACKGROUND

### Technical Field

The present disclosure relates generally to wireless communication and sensing, and for example to integrated sensing and communication (ISAC).

### Technical Considerations

Spectrum scarcity is a real issue for future wireless networks, which will be compounded by wireless sensing applications due to transmission of periodic signals. In addition, future wireless networks are expected to be flexible and dynamic, suggesting an increase in random channel access. Intuitively, the probability of packet collisions, therefore, increases. As such, ISAC systems are being developed where the available resources are shared between communication and sensing.

Integrated sensing and communications (ISAC) systems, i.e., wireless-capable systems which can share and/or coordinate resources to perform both sensing and communication, have garnered a lot of attention from the industry and academia, and are envisioned to be the second functionality of future wireless networks. As such, leading wireless communication standardization entities, such as the wireless fidelity (Wi-Fi) Alliance and 3rd Generation Partnership Project (3GPP), have initiated research in to standardizing and enhancing sensing within wireless networks. However, the inclusion of wireless sensing into communication networks is not straightforward. The increase in wireless sensing applications, and consequently signals, will inevitably increase the network traffic, causing coexistence, scheduling and interference issues.

The difficulty in developing ISAC systems arises from the fact that sensing and communication may not be performed by the same device, and, except for monostatic radar, the SS transmission and sensing processing may not be done by the same device. Additionally, the variety in sensing applications and related parameters, performance metrics, etc., further complicate coordination and scheduling. As a result, coexistence and cohabitation are viable solution directions.

To this end, the relevant background technologies could be the random channel access mechanisms for Wi-Fi and power domain NOMA.

Wireless sensing and ISAC are entering the two major standardization efforts for Wi-Fi and cellular communication. The Wi-Fi standards have formed a task group—TG bf-WLAN Sensing—to determine the standards to achieve sensing between two or more devices with some performance conditions. The 3GPP have a study item on ISAC for Release 19. Currently, they are determining use-cases.

Wi-Fi networks use random access channel access, as such collisions are possible. While there are collision avoidance mechanisms for data transmissions, such schemes for sensing communications have not yet been discussed. Because sensing applications may utilize periodic and frequent transmissions, collision between data transmissions occur. Therefore, an interference management mechanism will become useful. In these networks, currently sensing or channel sounding can be done with a rate of 100 Hz. However, in recent discussions in the standards meetings (802.11 TGbf) contributors have pointed out that sensing implementations and applications which use more than 100 Hz sounding rate are also present (i.e., 500 Hz-2000 Hz). Therefore, the feasibility of increasing the maximum sounding rate is being discussed by O. Au, B. Wang, K.J. R. Liu, H. Q. Lai (Origin Wireless), “Sounding Rate Ceiling for WLAN Sensing,” DCN: 1621r0. However, an increase of the maximum sounding rate would result in more sensing traffic, which is undesirable due to the adding probability of collisions and less chance of channel access to communicating devices.

Improving the spectral efficiency and channel access probability in joint communication and sensing is a challenging task.

### SUMMARY

Methods and techniques are described herein for facilitating a reliable and robust communication and sensing data. For that purpose, the present disclosure provides methods and techniques to increase the spectral efficiency and channel access probability in joint communication and sensing (JCAS).

For example, a method is provided for receiving a wireless communication signal, the method comprising: receiving the wireless communication signal carrying a communication signal X comprising a reference signal Xₚ and a sensing signal Ŝ multiplexed non-orthogonally; determining sensing channel state information, CSI, Hₛ based on the received wireless communication signal and the sensing signal; determining a communication signal portion Rx of the received wireless communication signal based on the determined sensing CSI; determining a communication CSI Hₓ based on the communication signal portion of the received wireless communication signal and the reference signal; and obtaining the communication signal from the communication signal portion of the received wireless signal based on the communication CSI.

Furthermore, a device is provided for receiving a wireless communication signal comprising: a transceiver configured to: receive the wireless communication signal carrying a communication signal X comprising a reference signal Xₚ and a sensing signal Ŝ multiplexed non-orthogonally; and processing circuitry configured to determine sensing channel state information, CSI, Hₛ based on the received wireless communication signal and the sensing signal; determine a communication signal portion Rx of the received wireless communication signal based on the determined sensing CSI; determine a communication CSI Hₓ based on the communication signal portion of the received wireless communication signal and the reference signal; and obtain the communication signal from the communication signal portion of the received wireless signal based on the communication CSI.

The above mentioned circuitry may be any circuitry such as processing circuitry comprising one or more processors and/or other circuitry elements.

These and other features and characteristics of the presently disclosed subject matter, as well as the methods of operation and functions of the related elements of structures and the combination of parts and economies of manufacture, will become more apparent upon consideration of the disclosure herein with reference to the accompanying drawings, all of which form a part of this specification. It is to be expressly understood, however, that the drawings are for the purpose of illustration and description only and are not intended as a definition of the limits of the disclosed subject matter. As used in the specification and the claims, the singular form of “a,” “an,” and “the” comprise plural referents unless the context clearly dictates otherwise.

### BRIEF DESCRIPTION OF THE DRAWINGS

An understanding of the nature and advantages of various embodiments may be realized by reference to the following figures.

The terms Fig., Figs., Figure, and Figures are used interchangeably in the specification to refer to the corresponding figures in the drawings.

FIG. 1 is an exemplary system model of the present disclosure.

FIG. 2 is an exemplary wireless sensing scenario with a trigger-based wireless sensing instance.

FIG. 3 is an exemplary wireless sensing scenario with a non-trigger-based wireless sensing instance.

FIG. 4 is an exemplary protocol for Wi-Fi sensing employing NOMA sensing in conjunction with the sensing STA transmitting NDP sensing signals.

FIG. 5 is an illustration of communication signals comprising data and pilot symbols, and sensing signals (symbols) received at the joint communication and sensing receiver.

FIG. 6 is an illustration of overlapping pilot symbols of the communication signal and sensing signals, so that the communication CSI and sensing CSI area not available.

FIG. 7 is a flowchart of the iterative estimation of the sensing CSI and communication CSI, with steps shown executed by the joint communication and sensing receiver.

FIG. 8a is a block diagram illustrating an exemplary receiver performing joint communication and sensing.

FIG. 8b is a block diagram illustrating an exemplary implementation of memory 810 of the receiver of FIG. 8a.

FIG. 9 is an illustration of embodiments of the present disclosure, comprising the channel access mechanism, the timing offset estimation, and the iterative CSI estimation.

FIG. 10 is a benchmark plot BER versus SNR and, respectively, MSE versus SNR, comparing the iterative CSI determination of the present disclosure with conventional approaches.

Like reference numbers and symbols in the various figures indicate like elements, in accordance with certain example implementations.

### Description

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosed subject matter as it is oriented in the drawing figures. However, it is to be understood that the disclosed subject matter may assume various alternative variations and step sequences, except where expressly specified to the contrary. It is also to be understood that the devices and processes illustrated in the attached drawings, and described in the following specification, are simply exemplary embodiments or aspects of the disclosed subject matter. Hence, dimensions and other physical characteristics related to the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to comprise one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Spectrum scarcity is a real issue for future wireless networks, which will be compounded by wireless sensing applications due to transmission of periodic signals. In addition, future wireless networks are expected to be flexible and dynamic, suggesting an increase in random channel access. However, with this increase, the probability of channel access collisions may increase, and hence may degrade the performance of wireless sensing and ISAC, where communication and sensing is performed in a time-overlapped manner.

Channel access, or the permission to transmit, in wireless networks can be divided into scheduled and random access. Scheduled access involves coordinating all the UEs operating on a frequency band such that their transmissions do not collide. This is only possible in controlled networks, like cellular networks and/or licensed spectrum networks, which constantly keep track of their UEs and have the processing power to do this. Random channel access is more suitable for low-cost, unlicensed spectrum networks, such as Wi-Fi. In these networks, the UEs may transmit without a pre-given order or agreement between itself and other devices. The drawback of this mechanism is frequent collisions. As such, various methods have been developed to decrease the probability of collisions and enable a fair channel access opportunity to all devices in the network.

Wi-Fi uses carrier sense multiple accessing with collision avoidance (CSMA/CA) mechanisms. Here, a station (STA) wishing to transmit listens to the channel for a period, known as arbitration interframe space (AIFS). If the channel is idle for this period, then the STA enters the backoff stage, where it again monitors the channel for a random contention window (CW) period. If a transmission is detected (channel is busy), the backoff countdown is paused and continued again when the channel is next detected free. If a transmission is not detected (channel is free), then the request-to-send (RTS) and clear-to-send (CTS) mechanism may be deployed. Here, the STA transmits an RTS packet and monitors the channel for a short interframe space (SIFS) period for the CTS packet. Upon receiving the CTS packet, the STA is now considered to have obtained the transmission opportunity (TXOP) and can transmit its packet(s). If the RTS-CTS mechanism is not employed, the STA will directly assume it has TXOP and will transmit its data. The receiving STA will then transmit an acknowledgement (ACK) packet SIFS after receiving the transmitted data. If the transmitting STA does not receive an ACK or CTS packet, then a collision is assumed. In this case, this process repeats from the beginning with the CW period doubled until it reaches the defined maximum value. If the retry limit is reached, then the packet is dropped. More information on this process can be found in the work by H. Fattah, “Analysis of the Channel Access Mechanism in IEEE 802.11 Wireless Local Area Networks,” 2007 IEEE Pacific Rim Conference on Communications, Computers and Signal Processing, 2007, pp. 74-77, doi: 10.1109/PACRIM.2007.4313180. Later, the enhanced distributed channel access mechanism was developed where access categories are defined for which the CW and TXOP vary-details may be found, for example, in the work by J.-C. Chen and K.-W. Cheng, “EDCA/CA: Enhancement of IEEE 802.11e EDCA by Contention Adaption for Energy Efficiency,” in IEEE Transactions on Wireless Communications, vol. 7, no. 8, pp. 2866-2870 Aug. 2008, doi: 10.1109/TWC.2008.070168. In this manner, priority is given to some communications over others, such as voice over backhaul communication.

There are multiple articles reporting on integrated sensing and communication (ISAC) involving non-orthogonal multiple access (NOMA) with a communication signal (CS) and radar signal.

For example, C. Ouyang, Y. Liu and H. Yang, “On the Performance of Uplink ISAC Systems,” in IEEE Communications Letters, vol. 26, no. 8, pp. 1769-1773 Aug. 2022, doi: 10.1109/LCOMM.2022.3178193 (referred to as Ref. [1]) show a base station (BS) transmits a sensing signal (SS) and receives its echo from a target while also receiving CSs from user equipment (UEs) (uplink (UL) communication). In their system model, the 2K communicating users (CUs) are paired into near CU and cell edge CU. Their received signal is the summation of the UL signals from the CU pair and the radar echo. Their assumptions are as follows:
the BS has two sets of spatially separated antennas to mitigate the self-interference due to the full duplex operation of the radar.
the BS knows the channels of the CUs perfectly.
the BS can remove the radar waveform reflected by the CUs perfectly.
the BS can remove the CSs from the radar perfectly.
the NOMA signals are aligned.

They perform successive interference cancellation (SIC) to decode the CSs. First, the radar signal is seen as interference and removed to get the UL signals from the CU pair. Then, the UL signals are subtracted, and the remaining radar signal is used for sensing. To decode the superimposed CSs, zero forcing combiner is applied to remove the inter-group interference (IGI). Finally, SIC is used to decode the received UL CSs.

The performance of the proposed method is compared in terms of outage probability, ergodic communication rate and sensing rate with the frequency division sensing and communication (FDSAC) scenario. They prove experimentally and analytically that for the same communication rate, their proposed system achieves a superior sensing rate to the FDSAC system.

The work by Z. Wang, Y. Liu, X. Mu and Z. Ding, “NOMA Inspired Interference Cancellation for Integrated Sensing and Communication,” ICC 2022-IEEE International Conference on Communications, 2022, pp. 3154-3159, doi: 10.1109/ICC45855.2022.9839026 (referred to as Ref. [2]) proposes a method for a downlink (DL) scenario where the SS is treated as a virtual CS. Their system model comprises of a multiple input multiple output (MIMO) antenna BS, single antenna UEs and multiple sensing targets. The BS transmits the CSs in different beams for each user. The SS is a multi-beam transmission and can be decomposed into multiple beams based on the rank. They embed information into a part of the SS and added to the communication signal before transmitting.

At the receiver, the UE receives the beamformed data signal, the interference from the other users' beamformed data signals (inter-user interference), and the interference from the SS. The SS interference can be removed partially by performing SIC. For this, the SS power may be higher than the communication signal power. The sensing beam patterns are omnidirectional if no prior information about the target locations is available. However, if prior information is available, then the beam pattern should have dominant peaks in the direction of the targets. They assume prior knowledge of the targets and aim to jointly optimize the overlapped communication and sensing beams such that they match the desired sensing beam pattern.

Their optimization problem is achieving minimum error between desired and optimized beam patterns while satisfying the SIC constraints, minimum communication rate and transmit power budget. This problem is non-convex due to the non-concave achievable rate constraint. They first convert the optimization to a convex problem by introducing a penalty term with a threshold value instead of the non-convex constraints. Then, they employ a successive convex approximation algorithm (Taylor expansion) and utilize a convex solver.

They compare their method against the following scenarios: 1. ideal sensing interference cancellation, 2. no sensing interference cancellation, 3. sole communication signal transmission, and 4. the SIC scheme with semidefinite relaxation. They find that their method outperforms the first two scenarios and only slightly performs worse than the fourth scenario in terms of average matching error and minimum rate.

The work by Mu, Xidong, Zhaolin Wang, and Yuanwei Liu. “NOMA for Integrating Sensing and Communications towards 6G: A Multiple Access Perspective.” arXiv preprint arXiv: 2206.00377 (2022) (referred to as Ref. [3]) outlines DL and UL sensing and communication NOMA scenarios. For DL, the scenario is different from [2] in that while the BS transmits both SSs and CSs, the sensing is done at the BS side (with the echo) and the data decoding is done by the UE. They state that the problem of communication to sensing interference is trivial as the BS knows the CS and can remove it, and analysis of the sensing echo is independent of the bits. However, the sensing to communication interference is an issue, especially in the case of insufficient spatial degrees of freedom. For the UL scenario, the SS is transmitted by the BS and the CS is transmitted by the UE. Both sensing and data decoding are done at the BS, as in [1].

For the DL scenario, they propose two designs, NOMA-empowered [3]-1 and NOMA-inspired ISAC [3]-2. In the former, superposition coding and SIC are used for transmitting and detecting the CS each UE. The echos of the superimposed CSs are also used for sensing. They validate their method against the conventional ISAC and show that they have a better effective sensing power and communication throughput performance. The NOMA-inspired design involves embedding all or part of the SS with information bits and transmitted with CSs, as in [2]. The information encoded SS will be detected and removed first using SIC. The information can be meaningless or contain a broadcast/multicast message to all the UEs.

For the UL scenario, they also propose two designs, pure-NOMA-based [3]-3 and semi-NOMA-based ISAC [3]-4. Here, the main problem is the mutual interference due to the SS echo and the CS. The former design is like NOMA communication where SIC is used, except that the decoding order may be CS first, then sensing. This has the disadvantage of limited communication rate due to the sensing interference, however, the echo signal strength is lower than the CS strength. The latter design involves dividing the radio resources into three orthogonal parts, the sensing only, sensing-communication, and communication only resource blocks. The sensing only and communication only resource blocks are processed as usual, and the sensing-communication resource block is processed as in the pure-NOMA-based design. The results are combined, giving better performance in terms of ergodic radar estimation rate and ergodic rate compared to the orthogonal ISAC and pure-NOMA-based ISAC design.

To summarize, some system model features and the solutions provided in the above-discussed works are given in the table below:

| | | | Sensing | Communication | | | |
|---|---|---|---|---|---|---|---|
| | | | Processing | Decoding | NOMA | | |
| Ref | SS | CS | Device | Device | Signal | Proposed Techniques | |
| [1] | Radar | Tx: CU | BS | BS | UL CU | 1. | CSI of CU assumed known, therefore |
| | Broadcast | Rx: BS | | | pair + | | radar is removed perfectly from CU signal |
| | | | | | Radar | 2. | IGI cancellation |
| | | | | | Echo | 3. | SIC for CU NOMA decoding |
| [2] | Radar | Tx: BS | BS | CU | DL + SS | 1. | Embed bits onto SS |
| | BF | Rx: CU | | | | 2. | Decode using SIC |
| | | | | | | 3. | SCA to optimize Tx beampattern such |
| | | | | | | | that it matched the desired beam pattern |
| | | | | | | | with constraints of power, minimum |
| | | | | | | | beam difference error, minimum |
| | | | | | | | communication rate |
| [3] | CS is | Tx: BS | BS | CU | DL | 1. | Superposition coding and SIC at CU |
| | used for | Rx: CU | | | | 2. | Radar processing at BS |
| | sensing | | | | | | |
| | Radar | Tx: BS | BS | CU | DL + SS | 1. | Embed bits onto SS |
| | | Rx: CU | | | | 2. | Decode using SIC at CU |
| | | | | | | 3. | Radar processing at BS |
| | Radar | Tx: CU | BS | CU | UL + SS | 1. | SIC |
| | | Rx: BS | | | | 2. | Radar processing |
| | Radar | Tx: CU | BS | CU | UL + SS | 1. | BW is divided into 3 parts: SS only, |
| | | Rx: BS | | | | | SS&CS, CS only |
| | | | | | | 2. | In SS only and CS only, processing is |
| | | | | | | | done as for radar and communication |
| | | | | | | 3. | In SS&CS, SIC is done to separate |
| | | | | | | | signals, then each signal is processed |
| | | | | | | 4. | The results are combined |

Further, patent application EP3892058A4 (referred to as Ref. [4]) describes a procedure and architecture for semi-orthogonal multiple accessing (SOMA) of the Wi-Fi physical layer protocol data unit (PPDU) and acknowledgement (ACK) packets. Here, the SOMA is achieved due to the superposing of some of the constellations in the PPDU and ACK signals and share the bandwidth. This patent describes the procedure of setting up a SOMA communication between two wireless devices, namely, the requesting of SOMA communication by one device, the reply (accept/decline) of a second device, the exchanging of capabilities, the exchanging (and negotiation) of parameters such as transmit power, and the SOMA transmission instance. Additionally, the control fields, elements, and parameters are broadly defined for the frames associated with the procedure steps above.

Refs. [1] to [3] apply power domain NOMA techniques as used in communication. This limits the potential to the disadvantages associated with power domain NOMA, which are many. For example, [1] assumes perfect knowledge of the CU channel, which is not available in practice without an initial OMA communication. Because the BS also knows the SS (radar), they assume that the radar signal can be perfectly removed from the communication signal. This is an ideal assumption, because even if a channel sounding mechanism occurs before the NOMA communication/sensing, the knowledge of the channel is limited to the target accuracy of the channel sounding mechanism. Additionally, the use of SIC to decode the CS necessitates a significant difference in signal powers at the receiver, which is not practical to arrange. In [2], the SS contains bits which are used to perform SIC, and thus a Tx power management scheme may be employed to ensure the power difference between the SS and CS. Additionally, their joint design optimization will suffer in scenarios where the target and CU are significantly separated. [3]-1 does in fact not apply NOMA to a SS and CU, but rather utilizes a known NOMA signal (DL signal) for sensing, which is known as passive sensing. Here, the disadvantages are that the transmitted signals by the CUs may not have the target parameters to attain the performance levels of the sensing application, such as bandwidth, Tx power and periodicity. Additionally, the sensing will be relative to the CUs position, which may not be (precisely) known. [3]-2 and [3]-3 are similar to [2] and [1] respectively and have the same disadvantages. In [3]-4 it is unclear how they divide combine the results of the three bandwidth sections, therefore it is not possible to comment on the results. Additionally, only in a portion of the available bandwidth does NOMA occur. Therefore, this does not bring the spectral efficiency of fully overlapping signals. In [4], the patent objective is not ISAC. Rather, they wish to achieve spectral efficiency by partially overlapping the PPDU and ACK packets. They did not describe a technical solution for separation of the overlapped constellations, but rather outlined the steps to identify capable devices and form pairwise link.

As noted before, one of the concerns is the increase in wireless sensing applications, and consequently signals, will inevitably increase the network traffic, causing coexistence, scheduling and interference issues.

One approach is to mitigate this problem is to design a waveform such that both the communication and sensing performance levels are satisfied with the same signal. However, meeting these levels results in trade-offs between sensing and communication performances. Scheduling-based approaches are also present, where the focus is on isolating the sensing and communication signals in the time and/or frequency domains. For example, TGbf, the task group responsible for incorporating sensing in Wi-Fi, has opted to transmit packets containing only training fields, or pilots, for sensing, using the same channel access mechanisms as the communication packets. This means that the sensing and communication transmissions will compete for transmission opportunity, which will degrade the communication capacity, especially if many sensing users (SUs) are present in the vicinity. As such, these methods are not resource efficient.

A different, more recent approach is non-orthogonal multiple access (NOMA)-ISAC. Here, the sensing signals and communication signals are overlapped, either at the transmitter or in the channel, and separated at the receiver(s). One such example is NOMA with two different waveforms, where an orthogonal frequency division multiplexing (OFDM) and frequency modulated continuous wave (FMCW) signal are overlapped. Other works either assume the sensing signal to be known and perfectly removable or assume the sensing signal as a virtual communication signal and apply successive interference cancellation (SIC). In the former, a radar echo is overlapped with an uplink signal at the ISAC base station. In the latter, a sensing signal and a communication signal are transmitted to the user equipment (UE), which removes the sensing signal and sends feedback information. Their aim is to jointly optimize the sensing and communication beams such that the communication performance is satisfied while the nearby objects are detected by the base station (BS). Both of these works consider beamforming communication and, as with most power domain NOMA works, assume perfect channel knowledge of the communicating UEs. This assumption is unrealistic, however, as the devices would have to do channel estimation with a non-NOMA signal beforehand. Furthermore, satisfying and maintaining the power difference criteria to apply SIC is difficult, more so in a mobile target and/or UE scenario. It is assumed that the sensing and communication signals are transmitted by the same device; i.e., sensing is done by a device which is also communicating, and ignore scenarios where the sensing and communication signals are transmitted by two different devices.

In general, a wireless system comprises a transmitter or a plurality of transmitters and a receiver of the wireless signal. The transmitter is capable of transmitting a signal to the receiver or to a group of receivers or to broadcast a signal over an interface. The interface may be any wireless interface. The interface may be specified by means of resources, which can be used for the transmission and reception by the transmitter and the receiver. Such resources may be defined in one or more (or all) of the time domain, frequency domain, code domain, and space domain. There may be separate devices including the functionality of the receiver and the transmitter, respectively. The transmitter and receiver may be implemented in any device such as a base station (eNB, AP) or terminal (UE, STA), or in any other entity of the wireless system. A device such as a base station, access point, or terminal may implement both receiver and transmitter. It is noted that in general, the “transmitter” and “receiver” may be also both integrated into the same device.

The present disclosure is not limited to any particular transmitter, receiver and/or interface implementation. However, it may be applied readily to some existing communication systems as well as to the extensions of such systems, or to new communication systems as mentioned above. Exemplary existing communication systems may be, for instance the 5G New Radio (NR) in its current or future releases, and/or the IEEE 802.11 based systems such as the recently studied IEEE 802.11be or the like. The wireless signal is not necessarily a communication signal in the sense that it does not necessarily carry out human or machine communication. It may be, for example, a sensing signal such as a radar signal or sounding a signal or any other kind of wireless signal from a wireless device such as, for example, some signal reporting (sensing) results to another device(s). The present disclosure is also applicable to other communication technologies such as 3G, communication technologies under long-term evolution (LTE)/LTE Unlicensed (LTE-U) or future communication technologies such as 6G standards or other future standards.

The present disclosure solves the above-discussed issues of multiple access of communication signal and sensing signal in networks using random channel access or scheduled channel access mechanisms by allowing them to use same time and frequency resources. In the present disclosure, it is assumed that the channel information of communication and sensing users are not known, and are obtained at the receiver side by an iterative channel estimation method. Also, a sensing signal timing offset estimation based on the received communication signal at the receiver is performed before the iterative channel estimation. Therefore, the present disclosure provides a non-orthogonal multiple access of communication and sensing signal without requiring extra time and frequency resources as compared to conventional communications systems.

The present disclosure provides a novel NOMA-ISAC scheme for channel state information (CSI)-based sensing where one device is a communicating user (CU) and the other is a SU. The transmitted OFDM signals are for instance the random communication signal and known sensing signal, and their subcarriers are fully overlapped at the receiver, where iterative channel estimation is applied. Compared to the conventional orthogonal ISAC (CO-ISAC) systems, where the sensing and communication signals are separated in time or frequency domains, the proposed system, ISAC with iterative channel estimation (ISAC-ICE) enables sharing these resources and can attain a satisfactory bit error rate (BER) and mean squared error (MSE) for communication and sensing performance, respectively. Thus, the spectral efficiency will be improved. This will be discussed in further detail in the following sections.

Orthogonal frequency division multiplexing (OFDM) is an example for a multicarrier waveform and has been used in numerous standards such as long-term evolution (LTE) and the IEEE 802.11 family due to its simple and effective structure. Owing to the overlapped orthogonal subcarriers, OFDM may use the spectrum efficiently. Moreover, the time frequency grid of OFDM allows for a flexible use of resource elements.

In an exemplary OFDM system, modulated data symbols for each data subcarrier are determined in the frequency domain by mapping information bits to the phase-shift keying (PSK)/quadrature amplitude modulation (QAM) constellation. A predetermined number of subcarriers are allocated for the transmission of pilot symbols (reference signals) to perform channel estimation. Channel coefficients may be estimated in the time-domain or frequency-domain. In the frequency domain, the channel frequency response is, for example, estimated by exploiting pilot symbols and may be interpolated to obtain the channel frequency response over data symbols.

The present disclosure is not limited to OFDM systems, but readily applicable to such systems used for communication purposes. Any system may be used that comprises reference signals in a transmitted signal.

In such a transmission, a wireless signal x propagates from a transmitter through a wireless channel H to a receiver. Such a wireless channel may be, for example, an IEEE 802.11 based wireless channel, a 5G New Radio (NR) based wireless channel or any other wireless channel. The transmitter can comprise one or more transmission antennas. The receiver can comprise one or more receiver antennas.

To properly demodulate the received wireless signal y, the effects of the channel such as, for example, scattering, fading, power decay with distance or the like, are taken into account. The characteristics of the wireless channel are usually obtained by a channel estimation. Channel estimation facilitates a reconstruction of the received signal and/or an adaption of a transmitted signal by estimating the channel properties of a communication link. For example, channel estimation is based on the reconstruction of reference signals known at both transmitter and receiver 30.

In non-limiting exemplary linear channel model, a received signal, denoted by vector y depends on a transmitted signal, denoted by vector x, by

$$y = Hx + n ,$$

where H is a so-called channel matrix and n is a noise vector. Such a noise vector may be modeled for example, by statistical types of noise such as white noise, Gaussian noise, or the like.

The components of said vector refer to subcarriers in the frequency domain. The frequency-domain input-output relationship for OFDM signal may be written as:

$$y ( a ) = h ( a ) x ( a ) + n ( a )$$

where a is subcarrier index.

Channel estimation may be performed based on a transmitted reference signal, denoted by vector Xₚ and a corresponding received signal, denoted by vector yₚ. Such a received reference signal yₚ may be comprised in the received signal y. The channel estimation here is estimation of elements of matrix H.

A channel estimation comprises an estimate Ĥ for the channel matrix H. For example, a least squares (LS) method or a linear minimum mean square error (LMMSE) method may be applied to obtain a channel estimation.

In some non-limiting exemplary (least squares) implementations, a channel estimation his is obtained from a received pilot symbol vector yₚ and a transmitted pilot symbol vector xₚ by

$${h}_{LS} ( p ) = \frac{{y}_{P} ( p )}{{x}_{P} ( p )} ,$$

where xₚ(p) and yₚ(p) are the transmitted pilot symbol and the corresponding received symbol at the p-th pilot subcarrier index. The pilot subcarrier index p may be chosen, for example, in the range from 1 to the number of subcarriers. The obtained values ĥ_{LS}(p) denote to the diagonal elements of the estimate Ĥ.

The pilot symbols may be continuous pilot symbols, or scattered pilot symbols or a combination thereof. The remaining elements of Ĥ are estimated based on the calculated values of his (k). Such estimation may comprise an interpolation or the like.

Such a linear channel estimation provides a way to obtain a signal reconstruction. However, a channel estimation as described above may not yield a suitable estimation for all frequencies, channel environments, channel impairments or the like. Thus, a refinement of the channel estimation may be desirable.

However, the above mentioned channel estimation is suitable only for the OFDM system. In case of NOMA as described above, this channel estimation may not perform well due to the interference between the sensing and the communication signals.

In order to enhance the spectral efficiency and the random access probability for communication and sensing, the non-limiting embodiments discussed below determine from a received wireless communication signal the channel state information (CSI) for both the sensing channel and the communication channel. This task may be performed, for example, by a receiving device that receives a communication signal (CS) and a sensing signal (SS) in a time-overlapped manner.

In the following, a method and an apparatus are discussed, which provide functionalities of determining the CSI-SS and the CSI-CS, which are used to obtain the communication signal from the received wireless communication signal.

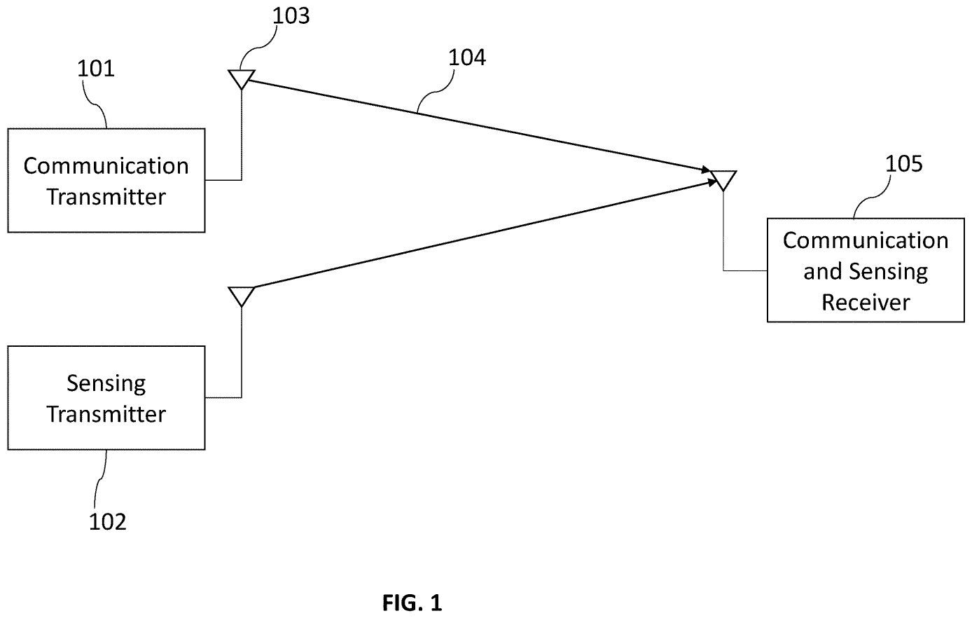

FIG. 1 shows a non-limiting example of the system model of the present disclosure. The model comprises a communication transmitter 101, sensing transmitter 102, antenna(s) 103 (FIG. 1-3), wireless channel links 104, and a joint communication and sensing (JCAS) receiver 105. In the example implementation of FIG. 1, the receiver 105 receives signals from separate communication and sensing transmitters, respectively. In other words, the system model comprises of two separate and independent single-antenna CU and SU transmitters, which simultaneously transmit their signals over a wireless channel to a single-antenna ISAC receiver. The OFDM communication symbol comprises pilot and data subcarriers, and the OFDM sensing symbol comprises sensing sequences. As they are transmitted simultaneously, the communication and sensing transmissions occupy the same time and frequency resources.

In the communication transmitter 101, information bits are modulated into symbols, which are then transformed into time domain, after digital-to-analog conversion. Orthogonal-frequency division multiplex (OFDM) is a currently rather popular wideband multi-carrier transmission technology and has been used in many standards such as IEEE 802.11 (Wi-Fi), LTE (Long Term Evolution, which is a mobile communication system of 4th generation, 4G), New Radio (NR, which belongs to 5th generation, 5G). In OFDM, frequency band is divided into subbands and these bands are called subcarriers. The data symbols, which are obtained by mapping incoming bits with a constellation pertaining to a modulation scheme, are transmitted simultaneously over these subcarriers. A certain number of subcarriers forms a resource unit (RU). For example, an RU may comprise 26, 52, 106, 242, 484 or 996 subcarriers. In Wi-Fi standards such as IEEE 802.11ax (Wi-Fi 6), there are several MCSs which allow to adjust the data rate and communication range. For example, MCSO corresponds to BPSK with ½ coding rate and it provides the most reliable communication and the lowest data rate among all MCSs. It is noted that the present disclosure can readily be applied to OFDM systems, but is not limited thereto. It is conceivable that the present disclosure may be applied in general to other schemes such as frequency division multiplexing (FDM) or Generalized FDM (GFDM) or filtered OFDM or the like. The OFDM or the FDM is not limited to using FFT, but may use discrete Fourier transformation (DFT) or other transformations. At the receiver side, the time domain signal is received. Samples belonging to an OFDM symbol are transformed by a (forward) transformation such as fast Fourier transformation or the like. Thereby, modulation symbols mapped onto the subcarriers are obtained and de-mapped. The term modulation here refers to mapping of one or more bits onto a signal point out of a plurality of signal points given by the modulation scheme. Arrangement of the signal points in the modulation scheme is sometimes also referred to as constellation. In case of BPSK, one bit of data is mapped onto one data symbol (modulation symbol). In the BPSK, the two possible signal points are typically antipodal, and represent two respective phases differing from each other by pi (180°). Then, the time domain signal passes through an RF-front end hardware components. In the sensing transmitter 102, a signal (i.e., a sensing signal SS) known by the joint communication and sensing receiver 105 passes through an RF-front end hardware components, and is transmitted after digital-to-analog conversion.

If this (sensing) signal is known only by the sensing transmitter 102 and the receiver 105, a secure sensing and communication will be provided. If it is not known by both sensing transmitter 102 and receiver 105, as is the case in conventional Institute of Electrical and Electronics Engineers (IEEE) 802.11bf systems, this will be not secure. Therefore, the knowledge of SS assumed known by the joint communication and sensing (JACS) receiver 105, but it may be also known by other receivers or not. The antenna 103 is used to send (i.e., transmit) the signal (e.g., communication signal CS) at the transmitter into the wireless channel 103. The channel link 104 changes the transmitted CS signal until reaching to the receiver antenna. After the receiving of the CS signal with the receiver antenna, the joint communication and sensing receiver 105 performs the analogue and digital processes to demodulate and decode the transmitted bits and estimate the channel characteristics of sensing transmitter. Such characteristics may, for example, be the channel state information (CSI) for the communication channel, i.e., the link over which the CS is transmitted from CS transmitter 101 to the JCAS receiver 105.

In conventional communication systems, the pilot symbols can be used to make wireless sensing. However, if the users do not transmit data packet(s) and desire the sensing for some applications, then the SSs are transmitted for wireless sensing as illustrated in FIG. 1. Although the joint communication and sensing receiver 105 is considered, the present disclosure can be similarly applied in a scenario of a separate communication receiver and sensing receiver.

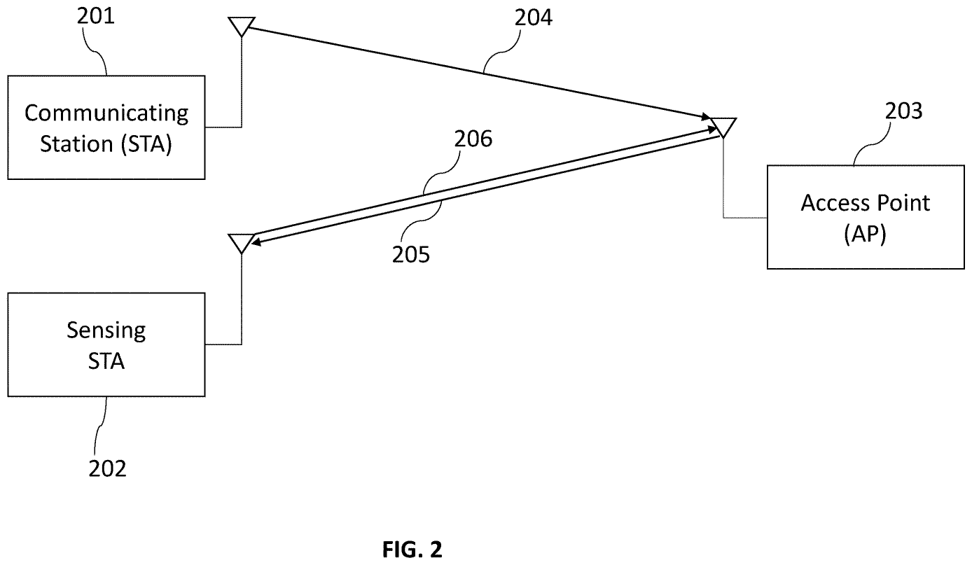

FIG. 2 shows an exemplary wireless sensing scenario in wireless fidelity (Wi-Fi) networks with a trigger-based (TB) wireless sensing instance. This scenario comprises a communicating station (STA) 201, a sensing STA 202, and an access point (AP) 203. Here, the SS transmission 206 is a null data packet (NDP), which is a standardized Wi-Fi transmission frame containing only the training and control fields. The NDP transmission 206 is initiated, when the AP 203 transmits a trigger signal 206, which requests an NDP signal from the STA 202. The AP 203, sensing STA 202, and the communicating STA 201 in FIG. 2 may perform the functions of the JACS receiver 105, the sensing transmitter 102, and the communication transmitter 101 of FIG. 1.

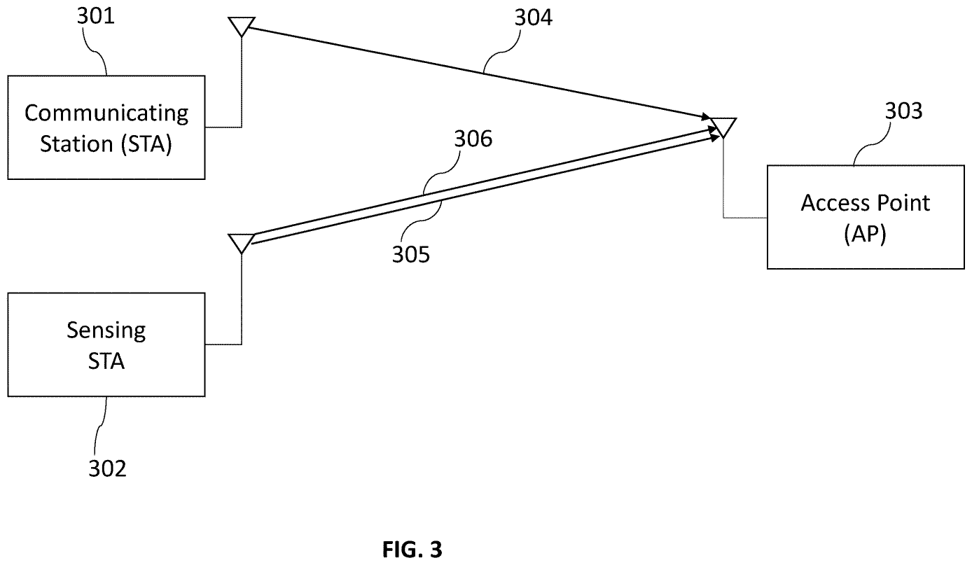

FIG. 3 shows a similar wireless sensing scenario in Wi-Fi networks as the one shown in FIG. 2, except with a non-trigger-based (non-TB) UL wireless sensing instance. Here, the main difference is that the AP 303 does not initiate the NDP 306 transmission. Instead, the sensing STA 302 transmits a signal indicating that its next transmission will be an NDP—this is called the NDP announcement (NDPA) 305 signal.

In both cases, the AP 203 in FIG. 2 and the AP 303 in FIG. 3 will make measurements on the NDP 206 and 306, respectively, and report these measurements results to the sensing STA 202 and 302. Another variant of the non-TB UL sensing instance is the non-TB DL sensing instance. In this case, the transmission of an NDPA 305 by the sensing STA 302 results in the transmission of an NDP 307 by the AP 303. Then, the sensing STA 302 performs the measurements on the received NDP 307 itself. In the examples depicted by FIG. 2/3, a CSMA/CA scheme is followed.

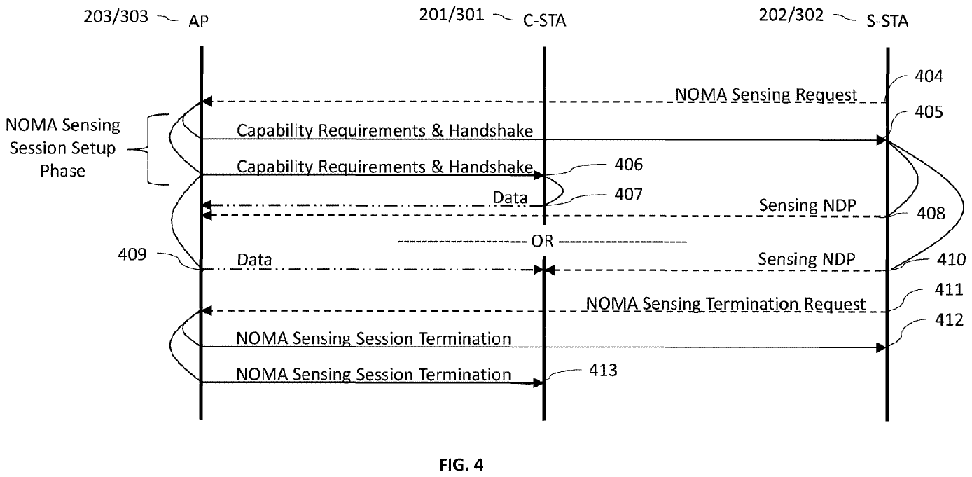

FIG. 4 depicts an exemplary protocol for Wi-Fi sensing in which the proposed technique can be used. First, a NOMA sensing session is requested 404 by the S-STA 202/302. Alternatively, this can be requested by the AP 203/303. Then, the NOMA sensing session setup phase commences 405 and 406. Here, the AP 203/303 may transmit control information, such as pilot ratio and training sequence 406 and 405, to the C-STA 201/301 and S-STA 202/302, respectively, and form a pairwise agreement between the participating devices. This means that there will be a handshake between AP—C-STA and AP—S-STA individually. This can entail a temporary change in the channel access mechanisms of the C-STA and the S-STA. For the C-STA 201/301, it may follow the normal Wi-Fi channel access mechanism, but when it senses a sensing signal or a sensing signal identifier, it may transmit its data signal rather than waiting for the channel to be empty for a duration of the countdown period. Similarly, the S-STA 202/302 may also follow the normal Wi-Fi channel access mechanism, except when it senses a communication signal from the C-STA or a communication signal identifier from the C-STA, then it may transmit its sensing NDP rather than waiting for the channel to be empty for a duration of the countdown period. Thus, the C-STA and S-STA can transmit their respective data 407 and sensing NDP signals 408 simultaneously. Alternatively, the AP can transmit a data signal 409 to the C-STA while the S-STA transmits a sensing NDP signal 410 to the C-STA. Here, note that there may be multiple C-STAs, which enter a pairwise handshake with the AP while only one S-STA may participate in this process. In both cases mentioned above (i.e., transmitting data 407 and sensing NDP 408—transmitting data 409 and sensing NDP 410) the transmissions may or may not be synchronized, and may overlap at least partially. In the former case (transmission pair of data 407 and sensing NDP 408), the proposed technique will be applied at the AP 203/303. In the latter case (transmission pair of data 409 and sensing NDP 410), the proposed technique will be applied at the C-STA 201/301. This case is also an example scenario for the collaborative sensing scenario, where the sensing NDP signal is transmitted to multiple devices, either by broadcast or sequentially, and all the devices are used to measure the signal. This NOMA sensing session will continue until a device transmits a NOMA sensing termination request. In the example, the S-STA 202/302 transmits the respective request 411, after which the AP 203/303 transmits the NOMA sensing session termination signal 413 and 412 to the C-STA 201/301 and S-STA 202/302, respectively. These termination signals end the handshake between the devices and resets their channel access mechanisms and parameters.

There are two different schemes to access the channel for the sensing transmitter 102. The first scheme is the non-orthogonal random channel access. In this scheme, the communication transmitter 101 transmits a signal (e.g., a communication signal CS) by using determined time and frequency resources. Then, the sensing transmitter 102 scans the spectrum for the SSs—if a SS is not detected, the sensing transmitter 102 starts to transmit the SS over the same time and frequency resources of the communication transmitter 101. Also, if the sensing transmitter 102 is transmitting a signal (e.g., a sensing signal SS) by using determined time and frequency resources, the communication transmitter 101 scans the spectrum for the CSs. If there is no detected CS in the spectrum, the communication transmitter 101 starts to transmit the CS, while the sensing transmitter 102 is transmitting. The second scheme is non-orthogonal scheduled channel access. In this scheme, communication transmitter 101 and sensing transmitter 101 are scheduled into same time and frequency resources by the joint communication and sensing receiver 105. Therefore, a synchronization process is used for the second scheme.

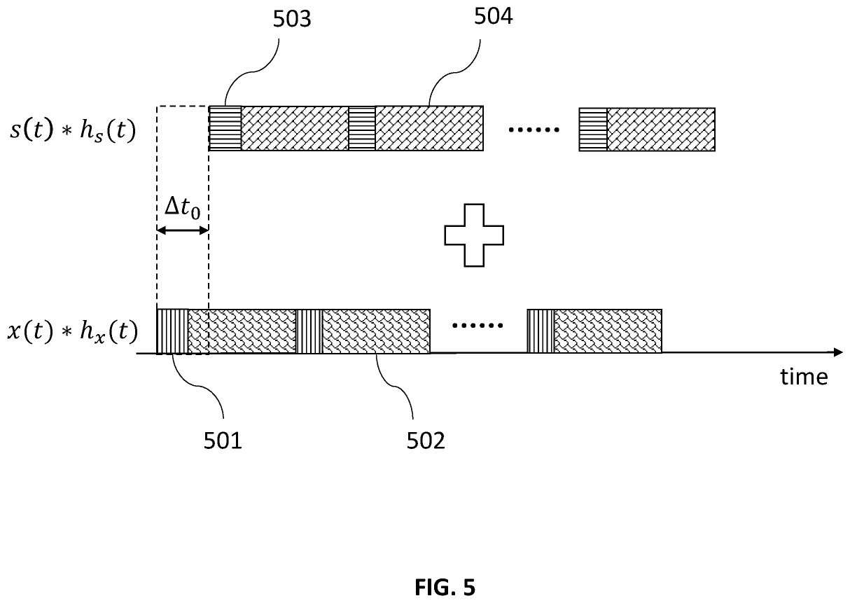

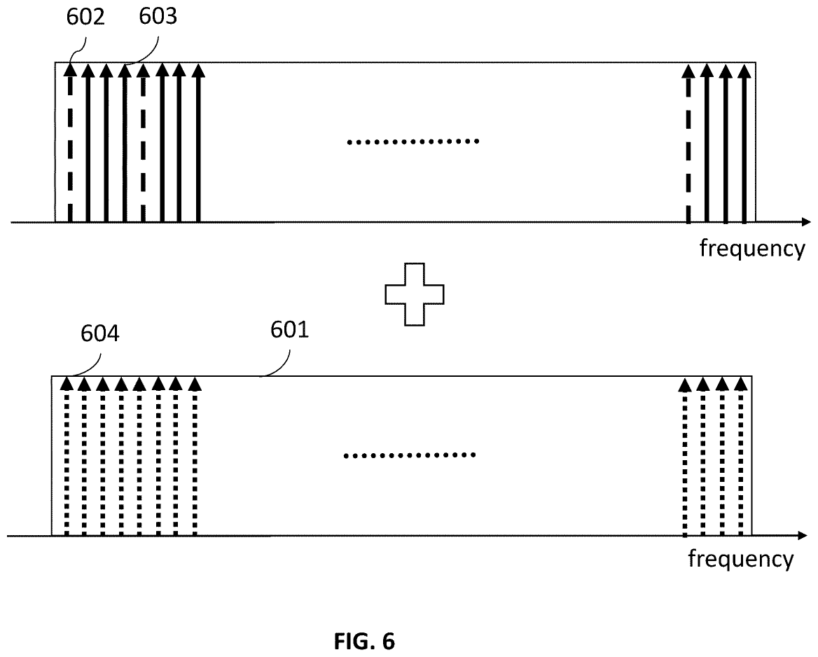

At the joint communication and sensing receiver 105, the received signals in the time domain are represented in FIG. 5. The signals shown are comprised in a wireless communication signal referred to as r (t) in the time-domain and to R (n) in the frequency domain. This means that the wireless communication signal carries a communication signal X that comprises a reference signal Xp, as well as a sensing signal S. The sensing signal and the communication signal are multiplexed non-orthogonally (NOMA). In the following, abbreviations CS and SS are used for communication signal and sensing signal for brevity. Hence, the CS and SS share same time-frequency resources. The wireless communication signal refers to a signal in which the communication signal and the sensing signal are represented by symbols, as obtained by an OFDM scheme, where bits representing the CS (data and reference signal) and bits representing sensing data are modulated based on a modulation scheme (M-ary modulation), such as BPSK, QPSK, QAM or the like. FIG. 5 illustrates the received communication symbols 501 and its cyclic prefix 502, and the received sensing symbols 503 and its cyclic prefix 504. The cyclic prefixes are assumed to be larger than the maximum excess delays of communication and sensing channels (i.e., the maximum channel delays), and are used for inter-symbol interference protection and circular channel convolution. The sensing signal may be a signal that is continuous or periodic. Moreover, in some non-limiting implementations, the sensing signal may be generated by a sensing application out of wireless sensing, wireless local area sensing, and non-invasive medical sensing.

The communication and sensing signals in the time domain are represented by x(t) and s(t), respectively. In some non-limiting implementations, x(t) and s(t) are transmitted by different devices, for example, by communication transmitter 101 and sensing transmitter 102 of FIG. 1. This means that the CS and SS are transmitted over different transmission channels, so that the CS and SS may suffer from different degree of path loss, fading, interference, etc. In other words, the sensing signal and the communication signal are being transmitted from a first transmission device (e.g., sensing transmitter 102 in FIG. 1) and a second transmission device (e.g., communication transmitter 101 in FIG. 1) that is different from the first transmission device. Alternatively, the first and second transmission device may be implemented in a common transmission device which transmits simultaneously the CS and SS. For example, in case of the common transmitter having multiple antennas, the common transmitter may simultaneously transmit the CS and SS using different antennas.

In some non-limiting implementations (i.e., CS and SS transmitter are separate devices), a timing offset Δt, occurs between these signals at the JACS receiver 105. Although the sensing symbols s(t) are considered to be known at the receiver 105, this signal will change due to the offset Δt₀. Therefore, in order to know where the received sensing symbols and hence the sensing signal is located in time-domain within the received wireless communication signal, the timing offset Δt₀ should be estimated first. The timing offset Δt, is also referred to as reception time offset.

The reception time offset of the sensing signal is determined from the wireless communication signal, starting with representing the received signal (i.e., the wireless communication signal) in the time-domain as:

$$r ( t ) = x ( t ) * {h}_{x} ( t ) + s ( t ) * {h}_{s} ( t ) + w ( t ) ,$$

where hₓ(t), hₛ(t), w(t), and * represent the communication channel, sensing channel, noise signal, and convolution operation, respectively. Note that the term communication/sensing channel refers to the (time-domain linear) channel response. Therefore, to estimate the reception time shift Δt₀, the cross correlation of the received wireless communication signal r (t) and the sensing signal s(t) is performed. Then, the time difference between the starting point of the received communication and sensing symbols gives the timing offset Δt₀, as illustrated in FIG. 5. Here, the starting point of the received communication signal is assumed as known. Then, the received sensing symbols is found as sᵣ(t)=s(t−Δt₀). In other words, the sensing signal is shifted by the reception time offset Δt₀. Therefore, the knowledge of the received sensing symbols within the symbols of the received wireless communication signal is obtained after the estimation of the timing offset.

Consider a conventional OFDM system where the communication and sensing symbols are obtained within an OFDM scheme, including M-ary modulation, multiplexing, etc. In this case, the sensing symbols may be a pilot sequence or sequence of reference symbols (i.e., reference signal), and OFDM symbol of the communication signal CS comprised in the received wireless communication signal r (t) will consist of both pilot sequence and data symbols. Therefore, after the CP removal from the received signal, in the frequency domain, the received symbols for an OFDM duration can be described as

$$R ( n ) = X ( n ) {H}_{x} ( n ) + \hat{S} ( n ) {H}_{s} ( n ) + W ( n ) , \qquad n = 0 , 1 , 2 , … , N - 1 ,$$

where X(n)=X_{d}(n)∪Xₚ(n) is the transmitted data symbols in the frequency domain that is the union of the data symbol X_{d}(n) and communication pilot symbol Xₚ(n). Hₓ (n) refers to the channel frequency response of the communication channel, Ŝ(n) is the time shifted version of transmitted sensing symbol S(n), and Hₛ(n) refers to the channel frequency response of the sensing channel. N is an integer equal to or larger than 1, and is the total number of subcarriers over a transmission band. In other words, the indices n label the frequencies of the subcarriers. The received symbols in the frequency domain are represented without considering channel effects in FIG. 5. FIG. 5 consists of a transmission band 501, data symbol X_{d}(n) 502, communication pilot symbol Xₚ(n) 503, and time-shifted sensing pilot symbol Ŝ(n) 504. As seen in FIG. 5, they use the same time and frequency resources—this is called non-orthogonal multiple access (NOMA) of communication and sensing symbols. Note that communication pilots and sensing pilots overlap, so that their channel state information (CSI) is not available at the JACS receiver (e.g., receiver 105 of FIG. 1). In this way, the sensing transmitter (e.g., transmitter 102 in FIG. 1) does not occupy an extra time and frequency resources, which would otherwise enhance the time-frequency resources. As trade-off, the communication and sensing performance can be degraded with an insignificant loss.

As already noted above, the CSI for the CS and SS are not known by the JACS receiver, so both CSI may be determined from the received wireless communication signal that carriers the CS and SS. Further, with the sensing signals known and their location within the wireless communication signal being determined and altered by the reception time offset, the CSI of the CS and SS can be determined, as discussed next. This is accomplished—after receiving the wireless communication signal—by determining the SS CSI based on the received wireless signal and the sensing signal. As mentioned earlier, the sensing signals are known and hence serve as reference signals to determine the SS CSI, similar as the pilot signals used for the CS CSI. Here, the sensing CSI is determined by using the received wireless communication signal, i.e., a respective symbol, using a least squares (LS) channel estimator dividing the wireless communication signal by the sensing signal, i.e., the sensing symbol. While the LS estimator may be used, other estimators may be suitable, for example, the minimum square estimator (MMSE).

With the SS CSI available, the JACS receiver determines a communication signal portion Rx of the received wireless communication signal based on the determined sensing CSI. This means that the product of the SS CSI and the sensing signal is subtracted from the wireless communication signal. This operation may be referred to as channel compensation, meaning that the undesired sensing component is eliminated from the originally received wireless signal—entailing a mixture of communication and sensing signals—to obtain said portion of the communication signal. Thereby, the term portion means symbol-wise determining the CSI. In this manner, the effects of sensing signal on communication signal are partially removed after this subtraction.

Now, with the communication signal portion determined, and hence known by the JACS receiver, the communication CSI Hₓ may be determined, based on the communication signal portion of the received wireless communication signal and the reference signal. In some non-limiting implementations, the LS estimator may be used, in which case the CS CSI is determined dividing the determined communication signal portion by the reference signal. As reference signal, the DM-RS or CRS-RS, etc., may be used. Alternatively, the reference signal may be a pilot signal. it is clear for those skilled in the art that other kind of reference/pilot signal may be used, as long as they are suitable for serving as reference to determine the quality of the respective channel (here the communication channel).

With the above processing, the communication signal portion and the CS CSI are now known by the JACS receiver, so that the communication signal (i.e., the communication symbol(s)) can now be obtained from the communication signal portion based on the communication CSI. This may be accomplished, for example, by demultiplexing and demodulating the CS symbol dividing the communication signal portion by the CS CSI.

Thus, the CS CSI, the SS CSI, and the communication signal may be determined without a prior knowledge of the CSIs of the communication channel and/or the sensing channel. This reduces the signaling overhead of providing such CSI parameters from a transmission device (e.g., transmitter 101 and/or transmitter 102 in FIG. 1) to the JACS receiver 105.

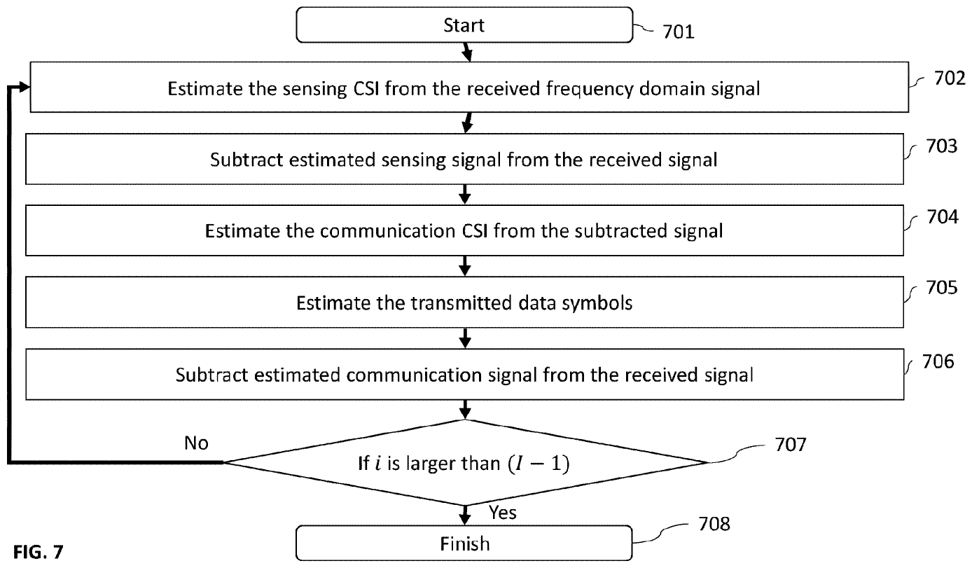

The SS CSI and the CS CSI may be determined in an iterative manner, in some non-limiting implementations. Iterative manner means that the JACS receiver performs the processing steps described before in sequence by repeating the respective steps. This is depicted in FIG. 7, showing the steps of iterative CSI estimations of sensing and communication channels at the receiver. For the iterative CSI estimation, the received frequency domain signal is given as:

$$R ( n ) = X ( n ) {H}_{x} ( n ) + \hat{S} ( n ) {H}_{x} ( n ) + W ( n ) .$$

The capitalized symbols have the same physical meaning as their lowercase symbols r (t), x (t) etc. in time-domain. In FIG. 7, the first step 701 is the starting algorithm after the above received signal is obtained. Then, at the i-th iteration step, the sensing CSI estimation is obtained by using least square (LS) channel estimation as:

$${H}_{s , LS}^{( i )} ( n ) = {R}_{s}^{( i - 1 )} ( n ) / S ( n ) , where {R}_{s}^{( 0 )} ( n ) = R ( n )$$

is the initial received signal for the sensing CSI estimation and i=1, 2, . . . , I being an integer labeling the iteration step i. Thereby, Rₛ refers to a sensing signal portion of the sensing signal, i.e., it refers to a sensing symbol. It is noted that the start of the iteration with i=0 corresponds to the respective processing step discussed above. We will revert to this point further below, highlighting the iterative nature of determining the CSIs for the SS and CS, and hence also the communication signal. As noted before, although the LS estimator is used here, a different estimator like minimum mean square estimator (MMSE) can also be used.

Afterwards, to improve the performance of the LS estimation, a discrete Fourier transform (DFT) based channel estimation is applied. Therefore, the sensing CSI vector

$${H}_{s , LS}^{( i )}$$

is converted into time domain. Then, only the first L time indices are taken, where L represents the maximum channel delay and indices larger than L contain only noise signals. In other words, the sensing channel response is subject to windowing in time domain by removing time responses that are lower than a first predefined threshold. This is done, since small time responses may no longer be differentiated from noise. The maximum channel response may be a first maximum channel response delay L1 for the sensing channel different from a second maximum channel response delay L2 for the communication channel (see below). Next, these L elements are transformed into frequency domain with N-point inverse DFT (IDFT) process to obtain the DFT-based channel estimation of the sensing CSI

$${H}_{s , DFT}^{( i )} .$$

The estimation of

$${H}_{s , DFT}^{( i )}$$

refers to une secona step 702 in FIG. 7. It is noted that the time-windowing of the sensing CSI may not be needed for the iterative determining of the SS CSI and CS CSI. However, the SS CSI time windowing may be used to obtain a more accurate SS CSI, as a result of the noise filtering via the time-windowing.

With the

$${H}_{s , DFT}^{( i )}$$

obtained, the estimated sensing signal can be subtracted from R(n) as:

$${R}_{k}^{( i )} ( n ) = R ( n ) - \hat{S} ( n ) * {H}_{s , DFT}^{( i )} ( n ) , where {R}_{x}^{( i )} ( n )$$

is the received communication signal after the estimated sensing signal is subtracted. Rₓ refers to the communication signal portion, with portion being a communication symbol. The obtaining

$${R}_{k}^{( i )} ( n )$$

refers to the third step 703 in FIG. 7. Again, for iteration step i=1, this corresponds to the respective processing step discussed before. As the above expression indicates, the sensing signal portion (i.e., an estimate thereof) is subtracted from the received wireless communication signal R, and hence compensated by the SS sensing signal portion. In other words, sensing signal interference in the communication signal portion is reduced.

Since the interference of the sensing signal on the received communication signal is decreased due to the subtraction, the communication CSI with LS estimator is obtained as:

$${H}_{x , LS}^{( i )} ( k ) = {R}_{k}^{( i )} ( n ) / {X}_{p} ( k ) ,$$

where k is the pilot indices for a communication symbol in the frequency domain, with pilot index may take values of k=1, . . . , N over all subcarrier indices. However, in practice, a subset of the N subcarrier indices may be used for the pilot index—for a given subcarrier index n for which the communication CSI is determined, n=a*k. This may be adapted to account for an index offset, so that the pilot index may read k=n/a+offset. To estimate the channel over all subcarriers, an interpolation for

$${H}_{x , LS}^{( i )} ( k )$$

is used to obtain

$${H}_{x , LS}^{( i )} ( n ) .$$

Then, DFT-based channel estimation may be performed like the processes that are done for

$${H}_{s , LS}^{( i )} ( n )$$

to obtain

$${H}_{s , DFT}^{( i )} ( n )$$

to improve the performance of the LS estimation. Again, a discrete Fourier transform (DFT) based channel estimation is applied. Therefore, the communication CSI vector

$${H}_{x , LS}^{( i )}$$

is converted into time domain. Then, only the first L time indices are taken, where L represents the maximum channel delay and indices larger than L contain only noise signals. In other words, the communication channel response is subject to windowing in time domain by removing time responses that are lower than a second predefined threshold. This is done, since small time responses may no longer be differentiated from noise. The maximum channel response may be a second maximum channel response delay L2 for the communication channel different from the first maximum channel response delay L1 for the sensing channel. Next, these L elements are transformed into frequency domain with N-point inverse DFT (IDFT) process to obtain the DFT-based channel estimation of the sensing CSI

$${H}_{x , DFT}^{( i )} ( n ) .$$

The estimation of

$${H}_{x , DFT}^{( i )}$$

refers to the fourth step 704 in FIG. 7.

After the estimation of

$${H}_{x , DFT}^{( i )} ( n ) , {R}_{x}^{( i )} ( n )$$

is equalized and the transmitted data symbol of the communication signal are demultiplexed and demodulated as \hat{X}⁽ⁱ⁾(n), which corresponds to a communication signal estimate. In other words, the communication signal estimate is obtained from the communication signal portion

$${R}_{x}^{( i )} ( n )$$

using the CSI

$${H}_{x , DFT}^{( i )} ( n ) .$$

Formally, this may be obtained from

$${R}_{x}^{( i )} ( n ) = {\hat{X}}^{( i )} ( n ) * {H}_{x , DFT}^{( i )} ( n )$$

by multiplying the expression with the inverse of the communication channel response. The estimation of \hat{X}⁽ⁱ⁾ refers to the fifth step 705 in FIG. 7. Since the transmitted symbols are detected and the accuracy of these symbols is very high if bit coding is used and channel condition is good, these data symbols can be utilized in decision-directed channel estimation to improve the accuracy of the communication channel.

Please note that the above processing corresponds to the previously discussed processing for single iteration step i=1. However, in the iterative SS CSI and CS determination, the sensing signal portion Rₛ is now updated so as to be used for the next iteration step i→i+1. This is done by compensating the channel according to the communication CSI. In other words, sensing and communication reverse their role in that now the communication interference on the sensing channel is reduced. For example, the communication channel

$${H}_{x , DFT}^{( i )} ( n )$$

is multiplied with the detected data symbol \hat{X}⁽ⁱ⁾(n), and it is subtracted from the wireless communication signal R(n) as:

$${R}_{s}^{( i )} ( n ) = R ( n ) - {\hat{X}}^{( i )} ( n ) * {H}_{x , DFT}^{( i )} ( n ) , where {R}_{s}^{( i )} ( n )$$

is the received sensing signal—at iteration step i—after the estimated data signal is subtracted. The obtaining of

$${R}_{s}^{( i )} ( n )$$

refers to the sixth step 706 in FIG. 7. This new, i.e., updated

$${R}_{s}^{( i )} ( n )$$

is now used in

$${H}_{s , LS}^{( i )} ( n ) = {R}_{s}^{( i - 1 )} ( n ) / \hat{S} ( n )$$

to determine the new, i.e., next SS CSI at the next iteration step. In this manner, the effects now of the communication signal on the sensing signal are partially removed after this subtraction. Hence, during the iteration, the mutual interference between the sensing signal and the communication signal are progressively reduced, providing for high separability of both signals.

If the iteration number i is smaller than (I−1), the steps between first and seventh step in FIG. 7 are repeated. This decision statement refers to the seventh step 707 in FIG. 7. Otherwise, the algorithm is terminated with the outputs of data symbols \hat{X}^{(I)}(n) of the communication signal, the communication CSI

$${H}_{x , DFT}^{( I )} ( n ) ,$$

and the sensing CSI

$${H}_{s , DFT}^{( I )} ( n ) .$$

This termination refers to the eighth step 708 in FIG. 7.

Determining the SS CSI and CS CSI in the iterative manner as describe above provides a good signal separability, i.e., the CS and SS are distinguishable with high accuracy, and hence do no longer interfere.

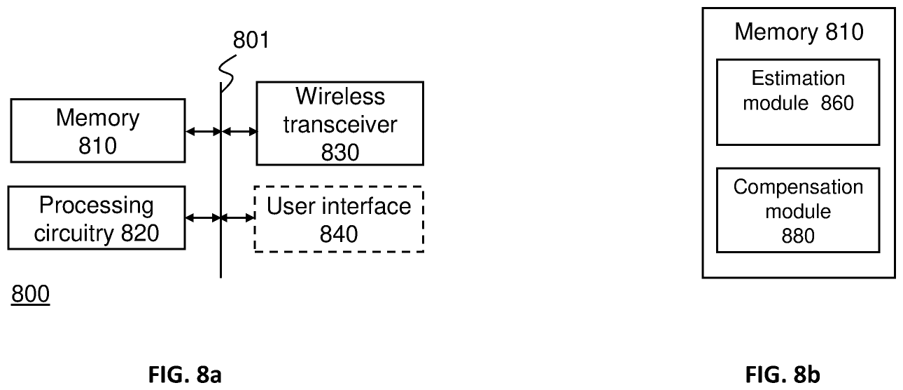

FIG. 8 illustrates a device 800 for receiving a wireless communication signal, which comprises processing circuitry 820. The processing circuitry is configured to perform the processing steps to determine the SS CSI, CS CSI, and the communication signal as discussed before, including the iterative determination. For example, the device 800 may be implemented to have separate units (or modules) for performing the respective processing step.

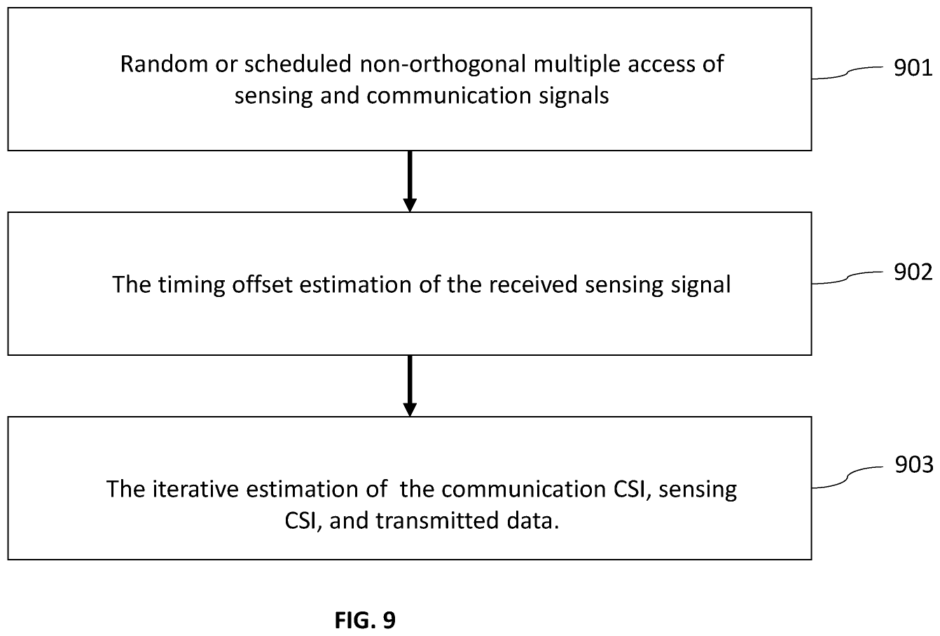

In summary, the present disclosure comprises three steps, as shown in FIG. 9, and as discussed above. Step 901 represents the channel access mechanism. In the present disclosure, a communication device scans the spectrum for a sensing signal, and if a communication signal is not detected and sensing signal detected, then starts to transmit. In conventional systems, the device uses an empty spectrum for both sensing and communication transmission. Step 902 represents the timing offset estimation of sensing signal. Because, although the sensing signal is assumed to be known by the receiver in many studies, it cannot be known without the timing offset estimation of the sensing signal. Step 903 represents the iterative estimation of communication and sensing channels and detection of transmitted data processing. Although certain iterative estimation techniques are known, the present disclosure applies improved methods as detailed herein for addressing certain problems with some modifications. Although an iterative estimation is described in the present disclosure, a machine learning algorithm can be also used to estimate the channels and detect the transmitted data.

The present disclosure may provide the following advantages:
increase of spectral efficiency by providing a method to separate and decode overlapped communication and sensing signals.
for Wi-Fi networks, improvement of the spectral efficiency and channel access probability by allowing sensing signals to be transmitted on top of communication signals.

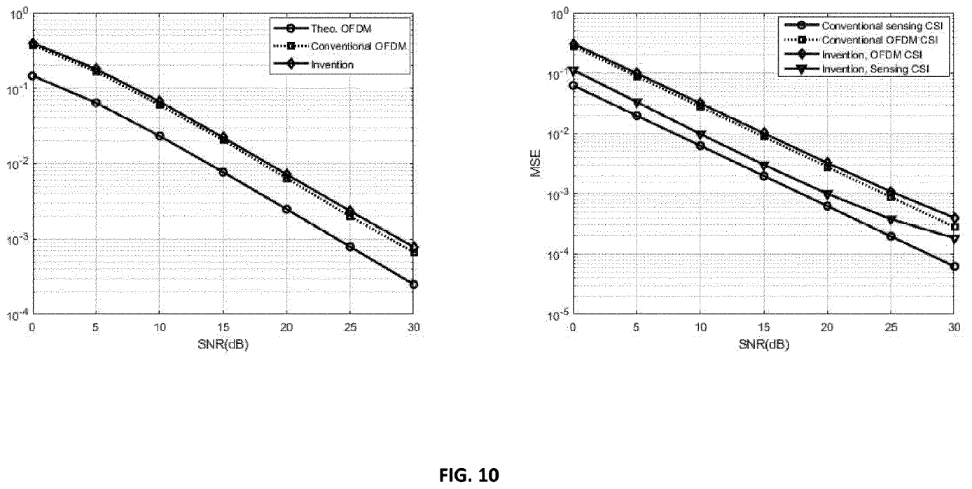

In order to assess the capabilities of the approach of the present disclosure, FIG. 10 compares the bit error rate (BER) and minimum square error (MSE) performances of the present approach (referred to as present in FIG. 10) with conventional approaches. As seen from the figure, the approach of the present disclosure degrades the BER insignificantly as compared to conventional OFDM systems. Moreover, the loss can be decreased by developing more advanced estimation and detection methods. For the channel estimation performances, although the estimation OFDM CSI has an insignificant loss, the estimation of sensing CSI has a significant loss. However, as mentioned before, these losses can be decreased by developing new methods or using advanced methods. In this way, sensing signals can be transmitted by using same time and frequency resources of communication signals.

Embodiments of the present disclosure may be suitable for devices communicating or sensing using Wi-Fi and cellular networks in conjunction with WIFI standards, such as 802.11bf: The sensing task group of the Wi-Fi WLAN standards and/or 3GPP: The standardization entity for cellular communications.

It is noted that although embodiments and examples of the present disclosure were provided in terms of a method above, the corresponding devices providing the functionality described by the methods are also provided. Moreover, it is noted that any of the steps described above may be comprised as code instructions in a program, which may be executed by one or more processors.

The methodologies described herein may be implemented by various means depending upon the application. For example, these methodologies may be implemented in hardware, operation system, firmware, software, or any combination of two or all of them. For hardware implementations, any processing circuitry may be used, which may include one or more processors. For example, the hardware may comprise one or more of application specific integrated circuits (ASICs), digital signal processors (DSPs), digital signal processing devices (DSPDs), programmable logic devices (PLDs), field programmable gate arrays (FPGAs), processors, controllers, any electronic devices, and/or other electronic circuitry units or elements designed to perform the functions described above.

If implemented as program code, the functions performed by the transmitting apparatus (device) may be stored as one or more instructions or code on a non-transitory computer readable storage medium. The computer-readable media comprises physical computer storage media, which may be any available medium that can be accessed by the computer, or, in general by the processing circuitry. Such computer-readable media may comprise RAM, ROM, EEPROM, optical disk storage, magnetic disk storage, semiconductor storage, and/or other storage devices. Some non-limiting examples comprise compact disc (CD), CD-ROM, laser disc, optical disc, digital versatile disc (DVD), Blu-ray (BD) disc and/or the like. Combinations of different storage media are also possible—in other words, distributed and heterogeneous storage may be employed.

FIG. 8a shows an exemplary device 800, which may implement some embodiments of the present disclosure. Such a device may comprise memory 810, processing circuitry 820, a wireless transceiver 830, and possibly a user interface 840. The device may be, for instance a (part of) a base station or a terminal/STA, or any other device, which receives wireless signals.

The memory 810 may store the program, which may be executed by the processing circuitry 820 to perform steps of any of the above-mentioned methods. The processing circuitry may comprise one or more processors and/or other dedicated or programmable hardware. The wireless transceiver 830 may be configured to receive and/or transmit wireless signals. The transceiver 830 may comprise also baseband processing which may detect, decode and interpret the data according to some standard or predefined convention. The device 800 may further comprise a user interface 840 for displaying messages or status of the device, or the like and/or for receiving a user's input. A bus 801 interconnects the memory, the processing circuitry, the wireless transceiver, and the user interface.

FIG. 8b provides an exemplary implementation of a memory 810, comprising classifier module 860 and a refinement module 880. It is noted that this implementation is only exemplary. There may be a different architecture for implementing the classifying or refinement, or any combination of those.

For example, the exemplary device 800 may be configured for receiving a wireless communication signal. The device 800 has a user interface 840 by which, for example, a user may configure the device 800 or any of the memory 810, processing circuitry 820, or wireless transceiver 830 by providing configuration parameters (setting parameters) via the bus 801. The device may comprise processing circuitry 820 that is configured to execute processing steps such as receiving the wireless communication signal carrying a communication signal X comprising a reference signal Xₚ and a sensing signal Ŝ multiplexed non-orthogonally. The reception of the wireless communication signal may be received via wireless transceiver 830, and then directed via bus 801 to processing circuitry 820 for further processing. The circuitry 820 then determines sensing channel state information, CSI, Hₛ based on the received wireless signal and the sensing signal. In a subsequent processing, the circuitry determines a communication signal portion Rₓ of the received wireless communication signal based on the determined sensing CSI, followed by determining a communication CSI Hₓ based on the communication signal portion of the received wireless communication signal and the reference signal. Finally, the processing circuitry obtains the communication signal from the communication signal portion of the received wireless signal based on the communication CSI.

The exemplary device 800 may be configured to perform any of the method described herein.

The processing circuitry 820 may perform the above processing steps according to a computer program that is stored on a non-transitory and computer readable medium. The computer program comprises instructions which when executed on one or more processors perform any of the above processing steps. The non-transitory computer readable medium may be memory 810 that stores the computer program. The computer program may have program modules for channel estimation processing and channel compensation processing. This is illustrated in FIG. 8b, where memory 810 includes estimation module 860 and compensation module 880.

The above examples are not to limited the present disclosure. There are many modifications and configurations, which may be used in addition or alternatively. This present disclosure can be used in any kind of device that is receiving signals over a wireless channel. The embodiments and exemplary implementations mentioned above show some non-limiting examples. It is understood that various modifications may be made without departing from the disclosed subject matter. For example, modifications may be made to adapt the examples to new systems and scenarios without departing from the central concept described herein.

According to a non-limiting aspect, a method is provided for receiving a wireless communication signal, the method comprising: receiving the wireless communication signal carrying a communication signal X comprising a reference signal Xₚ and a sensing signal § multiplexed non-orthogonally; determining sensing channel state information, CSI, Hₛ based on the received wireless signal and the sensing signal; determining a communication signal portion Rₓ of the received wireless communication signal based on the determined sensing CSI; determining a communication CSI Hₓ based on the communication signal portion of the received wireless communication signal and the reference signal; and obtaining the communication signal from the communication signal portion of the received wireless signal based on the communication CSI.

In some non-limiting implementations, the steps of determining of the sensing CSI, the communication signal portion, and the communication CSI being performed by iteratively executing steps of: i) determining the sensing CSI using a sensing signal portion Rₛ and the sensing signal according to:

$${H}_{s}^{( i )} = {R}_{s}^{( i - 1 )} / \hat{S}$$

wherein the received wireless communication signal being used as the sensing signal portion using

$${R}_{s}^{( i = 0 )} = R$$

at start of the iteration with i being an integer equal to or larger than zero; ii) determining the communication signal portion by subtracting from the received wireless communication signal a product of the sensing CSI and the sensing signal according to:

$${R}_{x}^{( i )} = R - {H}_{s}^{( i )} * \hat{S} ,$$

iii) determining the communication CSI by dividing the communication signal portion by the reference signal according to:

$${H}_{x}^{( i )} = {R}_{x}^{( i )} / {X}_{p} ,$$

iv) obtaining, by demultiplexing and demodulating, a communication signal estimate \hat{X}⁽ⁱ⁾ from the communication signal portion

$${R}_{x}^{( i )}$$

using the communication CSI

$${H}_{x}^{( i )} ;$$

and v) determining the sensing signal portion used in a next iteration step by subtracting from the received wireless communication signal a product of the communication CSI and the communication signal estimate according to:

$${R}_{s}^{( i )} = R - {H}_{x}^{( i )} * {\hat{X}}^{( i )} .$$

For example, the determining of the sensing CSI comprises determining a reception time offset of the sensing signal from the wireless communication signal.

In some non-limiting example implementations, the determining of the reception time offset comprises: correlating the wireless communication signal and the sensing signal providing the reception time offset; and shifting the sensing signal by the reception time offset.

According to some non-limiting implementations, the determining of the sensing CSI further comprises: transforming, for a sensing symbol, the sensing CSI Hₛ(n) from the frequency domain into the time-domain; keeping values of the time-domain sensing CSI Hₛ(l) for first L1 time indices; transforming, for the sensing symbol, the time-domain sensing CSI with the first L1 time indices from the time-domain into the frequency-domain; wherein n=0, . . . , N−1, and N being an integer equal to or larger than 1 indicating indices n of frequencies; and l=1, . . . , L1, and L1 being an integer equal to or larger than 1, and representing a first maximum channel delay.

According to some non-limiting implementations, the determining of the communication CSI further comprises: transforming, for a communication symbol, the communication CSI Hₓ (n) from the frequency domain into the time-domain; keeping values of the time-domain communication CSI Hₓ (l) for the first L2 time indices; transforming, for the communication symbol, the time-domain communication CSI with the first L₂ time indices from the time-domain into the frequency-domain; wherein n=0, . . . , N−1, and N being an integer equal to or larger than 1 indicating indices n of frequencies; and l=1, . . . , L₂, and L₂ being an integer equal to or larger than 1, and representing a second maximum channel delay.

In some non-limiting examples, the sensing signal is a signal being continuous or periodic. According to a further non-limiting example, the sensing signal is a signal generated by a sensing application out of wireless sensing, wireless local area sensing, non-invasive medical sensing.

In some non-limiting exemplary implementations, the communication signal being transmitted by a first transmission device and the second signal being transmitted from a second transmission device different from the first transmission device.

According to some non-limiting implementations, further steps comprise: receiving, by an access point, a request for non-orthogonal multiple access (NOMA) sensing from a sensing station; transmitting, by the access point, control information including capability requirements and handshake to the sensing station and a communication station.

In some non-limiting implementations, the receiving of the wireless communication signal is performed by the access point or a communication station, and the sensing signal is Null Data Packet (NDP).

In some non-limiting implementations, further steps comprise: transmitting, by the access point, communication data to the communication station.

According to some non-limiting implementations, the method further comprises: receiving, by the access point, a request for terminating the NOMA sensing from the sensing station; transmitting, by the access point, a NOMA sensing termination signal to the sensing station; and transmitting, by the access point, the NOMA sensing termination signal to the communication station.

According to some non-limiting aspects, provided is a computer program stored on a non-transitory and computer readable medium, wherein the computer program comprises instructions which when executed on one or more processors perform the method according to any of the aspects and exemplary implementations mentioned herein.

According to some non-limiting aspects, a device is provided for receiving a wireless communication signal comprising: processing circuitry configured to: receive the wireless communication signal carrying a communication signal X comprising a reference signal Xₚ and a sensing signal Ŝ multiplexed non-orthogonally; determine sensing channel state information, CSI, Hₛ based on the received wireless signal and the sensing signal; determine a communication signal portion Rₓ of the received wireless communication signal based on the determined sensing CSI; determine a communication CSI Hₓ based on the communication signal portion of the received wireless communication signal and the reference signal; and obtain the communication signal from the communication signal portion of the received wireless signal based on the communication CSI.

According to some non-limiting implementations, the processing circuitry is further configured to iteratively: i) determine the sensing CSI using a sensing signal portion Rₛ and the sensing signal according to:

$${H}_{s}^{( i )} = {R}_{s}^{( i - 1 )} / \hat{S} .$$

wherein the received wireless communication signal being used as the sensing signal portion using

$${R}_{s}^{( i = 0 )} = R$$

at start of the iteration with i being an integer equal to or larger than zero; ii) determine the communication signal portion by subtracting from the received wireless communication signal a product of the sensing CSI and the sensing signal according to:

$${R}_{x}^{( i )} = R - {H}_{s}^{( i )} * \hat{S} ,$$

iii) determine the communication CSI by dividing the communication signal portion by the reference signal according to:

$${H}_{x}^{( i )} = {R}_{x}^{( i )} / {X}_{p} ,$$

iv) obtain, by demultiplexing and demodulating, a communication signal estimate \hat{X}⁽ⁱ⁾ from the communication signal portion

$${R}_{x}^{( i )}$$

using the communication CSI

$${H}_{x}^{( i )} ;$$

and v) determine the sensing signal portion used in a next iteration step by subtracting from the received wireless communication signal a product of the communication CSI and the communication signal estimate according to:

$${R}_{s}^{( i )} = R - {H}_{x}^{( i )} * {\hat{X}}^{( i )} .$$

For example, the processing circuitry is further configured, for determining of the sensing CSI, to determine a reception time offset of the sensing signal from the wireless communication signal.

In some non-limiting implementation examples, the processing circuitry is further configured, for the determining of the reception time offset, to: correlate the wireless communication signal and the sensing signal providing the reception time offset; and shift the sensing signal by the reception time offset.

In some non-limiting implementations, the processing circuitry is further configured, for determining of the sensing CSI, to: transform, for a sensing symbol, the sensing CSI Hₛ(n) from the frequency domain into the time-domain; keep values of the time-domain sensing CSI Hₛ(l) for first L₁ time indices; transform, for the sensing symbol, the time-domain sensing CSI with the first L₁ time indices from the time-domain into the frequency-domain; wherein n=0, . . . , N−1, and N being an integer equal to or larger than 1 indicating indices n of frequencies; and l=1, . . . , L₁, and L₁ being an integer equal to or larger than 1, and representing a first maximum channel delay.

According to some non-limiting implementations, the processing circuitry is further configured, for determining of the communication CSI, to: transform, for a communication symbol, the communication CSI Hₓ (n) from the frequency domain into the time-domain; keep values of the time-domain communication CSI Hₓ (l) for the first L₂ time indices; transform, for the communication symbol, the time-domain communication CSI with the first L₂ time indices from the time-domain into the frequency-domain; wherein n=0, . . . , N−1, and N being an integer equal to or larger than 1 indicating indices n of frequencies; and l=1, . . . , L₂, and L₂ being an integer equal to or larger than 1, and representing a second maximum channel delay.

For example, the sensing signal is a signal being continuous or periodic. In a further example, the sensing signal is a signal generated by a sensing application out of wireless sensing, wireless local area sensing, and/or non-invasive medical sensing.

In some non-limiting implementations, the communication signal being transmitted by a first transmission device and the second signal being transmitted from a second transmission device different from the first transmission device.

According to some non-limiting implementations, the processing circuitry is further configured to: receive, by an access point, a request for non-orthogonal multiple access (NOMA) sensing from a sensing station; transmit, by the access point, control information comprising capability requirements and handshake to the sensing station and a communication station.

For example, the receiving of the wireless communication signal is performed by the access point or a communication station, and the sensing signal is Null Data Packet (NDP).

In another example, the processing circuitry is further configured to: transmit, by the access point, communication data to the communication station.

In some non-limiting implementations, the processing circuitry is further configured to: receive, by the access point, a request for terminating the NOMA sensing from the sensing station; transmit, by the access point, a NOMA sensing termination signal to the sensing station; and transmit, by the access point, the NOMA sensing termination signal to the communication station.

The examples and exemplary implementations described above for the methods apply in the same manner to the apparatuses. The processing circuitry may be further configured to perform the steps of one or more of the above-described embodiments and exemplary implementations.

According to some non-limiting embodiments, the processing circuitry and/or the transceiver is embedded in an integrated circuit, IC.

Although the disclosed subject matter has been described in detail for the purpose of illustration based on what is currently considered to be the most practical embodiments, it is to be understood that such detail is solely for that purpose and that the disclosed subject matter is not limited to the disclosed embodiments, but, on the contrary, is intended to cover modifications and equivalent arrangements that are within the spirit and scope of the disclosed subject matter. For example, it is to be understood that the presently disclosed subject matter contemplates that, to the extent possible, one or more features of any embodiment can be combined with one or more features of any other embodiment.

### LIST OF ACRONYMS

3GPP: 3^{rd} Generation Partnership Project
ACK: acknowledgement
AIFS: arbitration inter-frame spaces
AP: access point
BER: bit error rate
BS: base station
BW: bandwidth
C-STA: communication-STA
CS: communication signal
CSMA/CA: carrier sense multiple access with collision avoidance
CTS: clear-to-send
CU: communicating user
CW: contention window
DL: downlink
FDSAC: frequency division sensing and communication
IEEE: Institute of Electrical and Electronics Engineers
IGI: inter-guard interference
ISAC: integrated sensing and communication
MSE: minimum square error
NDP: null data packet
NOMA: non-orthogonal multiple access
OMA: orthogonal multiple access
PPDU: physical layer protocol data unit
RTS: request-to-send
S-STA: sensing-STA
SIC: successive interference cancellation
SIFS: short interframe space
SOMA: semi-orthogonal multiple accessing
SS: sensing signal
STA: station
SU: sensing user
TB: trigger-based
TXOP: transmission opportunity
UE: user equipment
UL: uplink
Wi-Fi: wireless fidelity

1. A method for receiving a wireless communication signal, comprising:
receiving the wireless communication signal carrying a communication signal X comprising a reference signal Xₚ and a sensing signal Ŝ multiplexed non-orthogonally;
determining sensing channel state information (CSI) Hₛ based on the received wireless communication signal and the sensing signal;
determining a communication signal portion Rₓ of the received wireless communication signal based on the determined sensing CSI;
determining a communication CSI Hₓ based on the communication signal portion of the received wireless communication signal and the reference signal; and
obtaining the communication signal from the communication signal portion of the received wireless signal based on the communication CSI.

2. The method according to claim 1, wherein determining of the sensing CSI, the communication signal portion, and the communication CSI are performed by iteratively:
i) determining the sensing CSI using a sensing signal portion Rₛ and the sensing signal according to:
$${H}_{s}^{( i )} = {R}_{s}^{( i - 1 )} / \hat{S}$$
wherein the received wireless communication signal being used as the sensing signal portion using
$${R}_{s}^{( i = 0 )} = R$$
at start of the iteration with i being an integer equal to or larger than zero;
ii) determining the communication signal portion by subtracting from the received wireless communication signal a product of the sensing CSI and the sensing signal according to:
$${R}_{x}^{( i )} = R - {H}_{s}^{( i )} * \hat{S}$$
iii) determining the communication CSI by dividing the communication signal portion by the reference signal according to:
$${H}_{x}^{( i )} = {R}_{x}^{( i )} / {X}_{p}$$
iv) obtaining, by demultiplexing and demodulating, a communication signal estimate \hat{X}⁽ⁱ⁾ from the communication signal portion
$${R}_{x}^{( i )}$$
using the communication CSI
$${H}_{x}^{( i )} ;$$
and
v) determining the sensing signal portion used in a next iteration by subtracting from the received wireless communication signal a product of the communication CSI and the communication signal estimate according to:
$${R}_{s}^{( i )} = R - {H}_{x}^{( i )} * {\hat{X}}^{( i )} :$$

3. The method according to claim 1, wherein the determining of the sensing CSI comprises determining a reception time offset of the sensing signal from the wireless communication signal.

4. The method according to claim 3, wherein the determining of the reception time offset comprises:
correlating the wireless communication signal and the sensing signal providing the reception time offset; and
shifting the sensing signal by the reception time offset.

5. The method according to claim 1, wherein the determining of the sensing CSI further comprises:
transforming, for a sensing symbol, the sensing CSI Hₛ(n) from the frequency domain into the time-domain;
keeping values of the time-domain sensing CSI Hₛ(l) for first L₁ time indices; and
transforming, for the sensing symbol, the time-domain sensing CSI with the first L₁ time indices from the time-domain into the frequency-domain;
wherein
n=0, . . . , N−1, and N being an integer equal to or larger than 1 indicating indices n of frequencies; and
l=1, . . . , L₁, and L₁ being an integer equal to or larger than 1, and representing a first maximum channel delay.

6. The method according to claim 1, wherein the determining of the communication CSI further comprises:
transforming, for a communication symbol, the communication CSI Hₓ(n) from the frequency domain into the time-domain;
keeping values of the time-domain communication CSI Hₓ(l) for the first L₂ time indices; and
transforming, for the communication symbol, the time-domain communication CSI with the first L₂ time indices from the time-domain into the frequency-domain;
wherein
n=0, . . . , N−1, and N being an integer equal to or larger than 1 indicating indices n of frequencies; and
l=1, . . . , L₂, and L₂ being an integer equal to or larger than 1, and representing a second maximum channel delay.

7. The method according to claim 1, wherein the sensing signal is a signal being continuous or periodic.

8. The method according to claim 1, wherein the sensing signal is a signal generated by a sensing application selected from wireless sensing, wireless local area sensing, and/or non-invasive medical sensing.

9. The method according to claim 1, wherein the communication signal is transmitted by a first transmission device and the second signal is transmitted from a second transmission device different from the first transmission device.

10. The method according to claim 1, further comprising:
receiving, by an access point, a request for non-orthogonal multiple access (NOMA) sensing from a sensing station; and
transmitting, by the access point, control information comprising capability requirements and handshake to the sensing station and a communication station.

11. The method according to claim 10, wherein:
the receiving of the wireless communication signal is performed by the access point or a communication station, and the sensing signal is Null Data Packet (NDP).

12. The method according to claim 11, wherein the method further comprises:
transmitting, by the access point, communication data to the communication station.

13. The method according to claim 11, wherein the method further comprises:
receiving, by the access point, a request for terminating the NOMA sensing from the sensing station;
transmitting, by the access point, a NOMA sensing termination signal to the sensing station; and
transmitting, by the access point, the NOMA sensing termination signal to the communication station.

14. A computer program product comprising a non-transitory and computer readable medium comprising instructions which, when executed on one or more processors, cause the one or more processors to perform the method of claim 1.

15. A device for receiving a wireless communication signal, comprising:
a transceiver configured to receive the wireless communication signal carrying a communication signal X including comprising a reference signal Xₚ and a sensing signal Ŝ multiplexed non-orthogonally;
processing circuitry configured to:
determine sensing channel state information (CSI) Hₛ based on the received wireless communication signal and the sensing signal;
determine a communication signal portion Rₓ of the received wireless communication signal based on the determined sensing CSI;
determine a communication CSI Hₓ based on the communication signal portion of the received wireless communication signal and the reference signal; and
obtain the communication signal from the communication signal portion of the received wireless signal based on the communication CSI.

16. The device according to claim 15, wherein the processing circuitry is further configured to iteratively:
i) determine the sensing CSI using a sensing signal portion Rₛ and the sensing signal according to:
$${H}_{s}^{( i )} = {R}_{s}^{( i - 1 )} / \hat{S}$$
wherein the received wireless communication signal being used as the sensing signal portion using
$${R}_{s}^{( i = 0 )} = R$$
at start of the iteration with i being an integer equal to or larger than zero;
ii) determine the communication signal portion by subtracting from the received wireless communication signal a product of the sensing CSI and the sensing signal according to:
$${R}_{x}^{( i )} = R - {H}_{s}^{( i )} * \hat{S}$$
iii) determine the communication CSI by dividing the communication signal portion by the reference signal according to:
$${H}_{x}^{( i )} = {R}_{x}^{( i )} / {X}_{p}$$
iv) obtain, by demultiplexing and demodulating, a communication signal estimate \hat{X}⁽ⁱ⁾ from the communication signal portion
$${R}_{x}^{( i )}$$
using the communication CSI
$${H}_{x}^{( i )} ;$$
and
v) determine the sensing signal portion used in a next iteration step—by subtracting from the received wireless communication signal a product of the communication CSI and the communication signal estimate according to:
$${R}_{s}^{( i )} = R - {H}_{x}^{( i )} * {\hat{X}}^{( i )} :$$

17. The device according to claim 15, wherein the processing circuitry is further configured, for determining of the sensing CSI, to determine a reception time offset of the sensing signal from the wireless communication signal.

18. The device according to claim 17, wherein the processing circuitry is further configured, for the determining of the reception time offset, to:
correlate the wireless communication signal and the sensing signal providing the reception time offset; and
shift the sensing signal by the reception time offset.

19. The device according to claim 15, wherein the processing circuitry is further configured, for determining of the sensing CSI, to:
transform, for a sensing symbol, the sensing CSI Hₛ(n) from the frequency domain into the time-domain;
keep values of the time-domain sensing CSI Hₛ(l) for first L₁ time indices; and
transform, for the sensing symbol, the time-domain sensing CSI with the first L₁ time indices from the time-domain into the frequency-domain;
wherein
n=0, . . . , N−1, and N being an integer equal to or larger than 1 indicating indices n of frequencies; and
l=1, . . . , L₁, and L₁ being an integer equal to or larger than 1, and representing a first maximum channel delay.

20. The device according to claim 15, wherein the processing circuitry is further configured, for determining of the communication CSI, to:
transform, for a communication symbol, the communication CSI Hₓ(n) from the frequency domain into the time-domain;
keep values of the time-domain communication CSI Hₓ(l) for the first L₂ time indices; and
transform, for the communication symbol, the time-domain communication CSI with the first L₂ time indices from the time-domain into the frequency-domain;
wherein
n=0, . . . , N−1, and N being an integer equal to or larger than 1 indicating indices n of frequencies; and
l=1, . . . , L₂, and L₂ being an integer equal to or larger than 1, and representing a second maximum channel delay.

21-27. (canceled)
